(19) United States
(12) Patent Application Publication
(10) Pub. No.: US 2025/0355308 A1
(43) Pub. Date: Nov. 20, 2025

(54) PHOTONIC CHIP PROVIDED WITH A MACH-ZEHNDER MODULATOR

(71) Applicant: SCINTIL PHOTONICS, GRENOBLE (FR)

(72) Inventors: Sylvie Menezo, Grenoble (FR); Zheng Yong

(73) Assignee: SCINTIL PHOTONICS, GRENOBLE (FR)

(21) Appl. No.: 18/872,458

(22) PCT Filed: Jul. 10, 2023
(86) PCT No.: PCT/EP2023/069059

§ 371 Date: Dec. 6, 2024

(30) Foreign Application Priority Data
Jul. 25, 2022 (FR) FR2207627

(51) Int. Cl. G02F 1/21; G02F 1/225; G02F 1/39

(52) U.S. Cl. CPC G02F 1/212; G02F 1/225; G02F 1/395; G02F 2203/70

(57) ABSTRACT

The invention relates to a photonic system provided with a photonic chip made in silicon technology, said photonic chip (10) comprising:—a Mach-Zehnder modulator (100) the modulation sections (105, 106) of which extend over a length L smaller than 3 mm;—first means (107) for adjusting operating point;—a semiconductor optical amplifier (SOA) configured to amplify a signal modulated by the Mach-Zehnder modulator, the semiconductor optical amplifier (SOA) being such that the amplitude of optical modulation associated with the photonic chip, when the set phase shift F is adjusted to the range 0.6*pi-0.9*pi, is of between −2 dBm and 6 dBm, at an output port S placed downstream of the semiconductor optical amplifier (SOA).

### FIELD OF THE INVENTION

The present invention relates to the field of photonics and more particularly integrated photonic chips.

In particular, the invention concerns a photonic chip provided with a Mach-Zehnder modulator configured to limit optical losses and featuring a bandwidth (at 3 dB) superior to that of Mach-Zehnder modulators known from the prior art.

The photonic chip advantageously comprises an optical transmitter.

### TECHNOLOGICAL BACKGROUND OF THE INVENTION

Optical modulators are widely used in optical transmitters to manipulate optical signals. Among known optical modulators, the Mach-Zehnder modulator is of particular interest when high light modulation speeds are required.

Thus, FIG. 1 shows a Mach-Zehnder modulator 1 of the prior art. The Mach-Zehnder modulator 1 in particular comprises two modulation branches, called first branch 2 and second branch 3, connected by one of their ends by at least one optical input 4 and by the other of their end by at least one optical output 5.

In particular, the two modulation branches 2 and 3 are arranged so that a light ray injected at the optical input 4 is divided into a first ray and a guided second ray, respectively, by the first branch 2 and the second branch 3, and so that said first ray and said second ray are recombined at the optical output.

The device is also provided with two phase modulators, called first modulator 6 and second modulator 7 intended to impose a phase shift, respectively, on the first ray and on the second ray before they are recombined at the optical output 5. The modification of the phase of one and/or the other of the first and of the second ray in particular makes it possible to modulate the intensity of the recombined ray at the output of the Mach-Zehnder modulator.

The Mach-Zehnder device further comprises a phase-shifting means for imposing an additional set phase shift q between the first branch 2 and the second branch 3. Conventionally, this set phase shift is generally equal to pi/2, which corresponds to an operating point of the Mach-Zehnder device known as “quadrature”, in order to linearize the output intensity modulation of said device as much as possible.

However, the consideration of a quadrature operating point limits the performance of a Mach-Zehnder device.

Thus, one aim of the present invention is to provide a photonic chip provided with a Mach-Zehnder modulator whose performance is improved compared with Mach-Zehnder devices or transmitters known from the prior art.

### BRIEF DESCRIPTION OF THE INVENTION

The aims of the invention are, at least in part, achieved by a photonic system provided with a photonic chip made in silicon technology, said photonic chip comprising:
a Mach-Zehnder modulator formed on and/or in a useful layer resting on one face of a supporting substrate, said Mach-Zehnder modulator comprising two modulation branches, called first branch and second branch respectively, each provided with a modulation section extending over a length L of less than 3 mm;
first means for adjusting the operating point of the Mach-Zehnder modulator, configured to impose an operating point associated with a set phase shift F between the first and second branches;
a semiconductor optical amplifier formed on and/or in the useful layer and arranged downstream of the Mach-Zehnder modulator output, said semiconductor optical amplifier being configured to amplify a signal modulated by the Mach-Zehnder modulator, the semiconductor optical amplifier having an optical gain configured so that the optical modulation amplitude associated with the photonic chip, when the set phase shift F is adjusted in the range 0.6*pi-0.9*pi, is between −3 dBm and 10 dBm, at an output port S arranged downstream of the semiconductor optical amplifier SOA.

In one embodiment, the first adjustment means comprises a first heating element configured to locally modify, by heating, the refractive index of either the first branch or the second branch in order to impose the set phase shift F.

According to one embodiment, said photonic system comprises first control means configured to control the first adjustment means.

In one embodiment, the first control means comprise a first photodetector and a first spectral analyzer.

According to one embodiment, the Mach-Zehnder modulator comprises a radiation combiner configured to combine a first radiation and a second radiation that are phase-modulated, respectively, by the first branch and the second branch, the first radiation and the second radiation originating, before they are modulated by one of the modulation branches, from the division of light radiation.

According to one embodiment, the photonic chip also comprises second means for adjusting an optical gain of the semiconductor optical amplifier, advantageously the second adjustment means comprise a second heating element.

According to one embodiment, said photonic system comprises second control means configured to control the second adjustment means, said second control means comprising a second photodetector and a second spectral analyzer.

According to one embodiment, the radiation combiner comprises two output channels referred to as, respectively, the first channel and second channel, the second channel carrying the semiconductor optical amplifier, the second control means being carried by a second control waveguide optically coupled to the second channel, the coupling being sized so that the second waveguide taps at most 10%, advantageously at most 5%, of the optical power flowing in the second channel.

According to one embodiment, the photonic chip also includes an optical filter carried by the second channel and downstream of the semiconductor optical amplifier.

In one embodiment, the photonic chip comprises a laser source configured to inject light radiation at wavelength I at an input to the Mach-Zehnder modulator.

In one embodiment, the laser source is a tunable laser source.

The invention also relates to the implementation of the photonic system according to the present invention, wherein the light radiation injected by the laser source is of an intensity strictly less than 10 dB, advantageously less than 7 dB, and wherein the gain of the semiconductor optical amplifier is adjusted so that the signal at the output of the photonic chip has an intensity equivalent to that obtained by the said photonic chip without a semiconductor optical amplifier and at the input of which radiation of an intensity of 10 dB would have been injected.

### BRIEF DESCRIPTION OF THE DRAWINGS

Other features and advantages of the invention will emerge from the following detailed description of the invention with reference to the appended figures, in which:

FIG. 1 is a schematic representation of a Mach-Zehnder device 1 known from the prior art;

FIG. 2 is a schematic representation of a Mach-Zehnder modulator capable of being implemented within the scope of the present invention;

FIG. 3 is a schematic representation of a support substrate on a face of which the waveguide layer is supported, and along a sectional plane perpendicular to the front face;

FIG. 4 is a graphical representation of the transfer function of a Mach-Zehnder modulator. In particular, the vertical axis (in arbitrary units) represents the intensity of modulated radiation as a function of the operating point F/pi (horizontal axis), with the double arrow representing the modulation amplitude for quadrature operation of the Mach-Zehnder modulator;

FIG. 5 is a graphical representation of the transfer function of a Mach-Zehnder modulator. In particular, the vertical axis (in arbitrary units) represents the power of modulated radiation as a function of the operating point F/pi (horizontal axis), with the double arrow representing the modulation amplitude for an operating point of the Mach-Zehnder modulator between 0.6*pi and 0.9*pi;

FIG. 6 is a graphical representation of an example eye diagram relating to the operation of a Mach-Zehnder modulator;

FIG. 7 is the spectral signature of the Mach-Zehnder modulator modulated around the quadrature point;

FIG. 8 is the spectral signature of the Mach-Zehnder modulator modulated around the carrier suppression point.

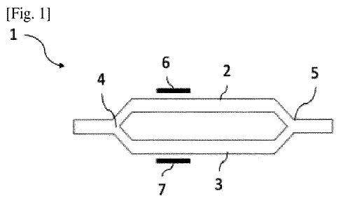

### DETAILED DESCRIPTION OF THE INVENTION

The invention relates to a photonic system provided with a photonic chip. In particular, the photonic chip according to the present invention comprises a Mach-Zehnder modulator. The photonic chip is advantageously used to form a transmitter to which the photonic system can belong.

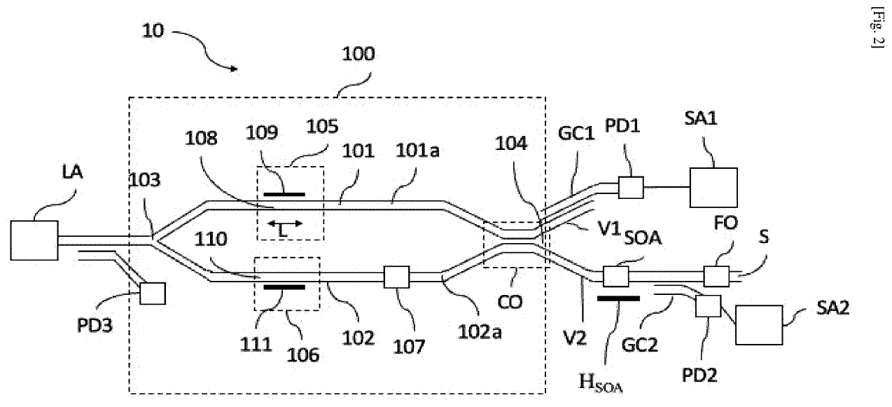

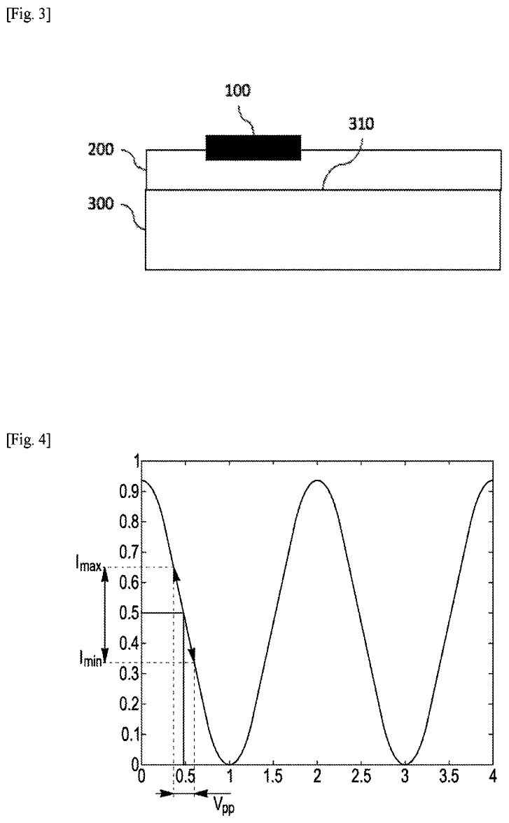

Thus, FIG. 2 is a schematic representation of a photonic system 10 provided with a Mach-Zehnder modulator 100 capable of being implemented within the scope of the present invention. In particular, the Mach-Zehnder modulator 100 can be formed on or in a layer, called a useful layer 200 resting on a front face 310 of a support substrate 300 (FIG. 3).

The photonic chip is based on silicon technology. In other words, all the waveguides forming the Mach-Zehnder modulator are made of silicon.

The support substrate 300 may comprise any type of materials, and more particularly a semiconductor material, for example silicon.

The useful layer 200 may comprise a semiconductor material, for example silicon or a III-V material. More particularly, the useful layer 200 may rest on a layer of dielectric material interposed between said useful layer 200 and the support substrate 300. By way of example, the Mach-Zehnder modulator can be formed on a silicon-on-insulator substrate.

The remainder of the description also involves a semiconductor amplifier SOA, which can be made from III-V semiconductor materials. In particular, the SOA can be made via either III-V semiconductor-on-silicon technology, SOA hybridization (assembly of the pre-fabricated SOA component with a silicon or SiNx waveguide) or hybrid or heterogeneous integration (molecular bonding of III-V semiconductor materials and formation of the III-V component). In this respect, the person skilled in the art will be able to consult documents [1] and [4] cited at the end of the description.

According to the terms of the present invention, a Mach-Zehnder modulator comprises two modulation branches, respectively called first branch 101 and second branch 102. The first branch 101 and the second branch 102 may be connected, at one of their ends, by an intermediate optical input 103, and, at the other of their ends, by an intermediate optical output 104.

More particularly, the first branch 101 and the second branch 102 each comprise a waveguide called, respectively, first waveguide 101a and second waveguide 102a. The first branch 101 and the second branch 102 each comprise a modulation section called, respectively, first modulation section 105 and second modulation section 106. The modulation section of a given modulation branch is configured to modulate the phase of a light ray capable of being guided by the modulation branch in question.

A modulation section of a modulation branch may in particular comprise a section of the waveguide of said branch, called the modulation waveguide, and an electrode intended to impose an electrical potential onto said modulation waveguide.

A modulation section is in particular configured so that an electrical potential imposed by the electrode on the modulation waveguide modifies the refractive index of the modulation waveguide in question. This index modification makes it possible to impose a phase shift on a light ray likely to be guided by the modulation section in question. In this respect, the modulation waveguide may comprise a doped silicon guide, and more particularly a silicon waveguide accommodating a PN junction. Such a waveguide has a refractive index capable of being modulated as a function of an electrical potential imposed on it. The document [2] cited at the end of the description provides an example that the person skilled in the art will be able to implement within the scope of the present invention. However, the invention is not limited to these aspects alone, and the person skilled in the art could consider other solutions. In particular, and by way of example, the first modulation waveguide 108 and the second modulation waveguide 110 may comprise a III-V semiconductor, for example, transferred by bonding to the substrate.

Thus, the modulation waveguide and the electrode of the first modulation section 105 called, respectively, first modulation guide 108 and first electrode 109, make it possible to impose a phase modulation, called first phase shift, onto a light ray guided by the first branch 101. This first phase shift is in particular modulated by the electric potential, called first potential, imposed by the first electrode 109.

In an equivalent manner, the modulation waveguide and the electrode of the second modulation section 106 called, respectively, second modulation guide 110 and second electrode 111, make it possible to impose a phase modulation, called second phase shift, onto a light ray guided by the second branch 102. This second phase shift is in particular modulated by the electric potential, called second potential, imposed by the second electrode 111.

According to the present invention, the first potential and the second potential may be equal to, respectively, u(t)/2 and −u(t)/2. In these conditions, the phase shift imposed by the first modulation section 105 and by the second modulation section 106 are equal to, respectively, Mu(t)/2 and −Mu(t)/2 (M is an efficiency factor of a modulator).

The second branch 102 generally comprises first adjustment means 107 (e.g. a phase-shift module) configured to impose a set phase shift F (also known as the Mach-Zehnder modulator's “operating point”, given in radians) on light radiation likely to be guided by said second branch 102, in addition to the phase shift −Mu(t)/2. These two radiations guided respectively by the first branch 101 and the second branch 102, are then recombined at the optical output 104 to form an output ray of intensity lout.

In this way, light radiation with intensity Iin is injected at the optical input 103. In particular, this radiation can be produced by a laser source LA, for example a tunable one, configured to inject said light radiation at wavelength I into an input of the Mach-Zehnder modulator. The light beam is divided into two beams to be guided by the first branch 101 and the second branch 102 respectively. The radiation guided by the first branch 101, known as the first radiation, undergoes a phase shift equal to Mu(t)/2, while the radiation guided by the second branch 102, known as the second radiation, undergoes a phase shift equal to −Mu(t)/2+F. These two radiations guided respectively by the first branch 101 and the second branch 102, are then recombined at the optical output 104 to form an output ray of intensity Iout. The intensity lout, depending on the phase shift imposed between the two modulation sections, can vary between a minimum intensity Imin and a maximum intensity Imax when u(t) varies between 0 and a voltage Vpp (Vpp can be limited to 2V, for example). FIG. 4 shows the transfer function (representing the intensity ratio Iout/Iin), represented by a sinusoidal function, of a Mach-Zehnder modulator as a function of F/pi. To ensure essentially linear behavior of the Mach-Zehnder modulator, the set phase shift F is generally fixed at pi/2 (the operating point is then said to be in “quadrature”).

The Mach-Zehnder modulator is characterized by at least two quantities, including the extinction ratio ER and the bandwidth BW.

The optical modulation amplitude OMA is also a relevant quantity discussed in the rest of the statement.

The extinction ratio ER (in dB) is defined as follows:

$$ER ( dB ) = 10 * log 10 ( \frac{{I}_{Max}}{{I}_{Min}} )$$

Where Imax and Imin are the maximum and minimum achievable intensities, respectively, for a given modulation voltage Vpp (shown in FIG. 4). This term is generally required to be greater than 4 dB.

The optical modulation amplitude (in dB) is defined by the following relationship:

$$OMA ( dBm ) = 10 * log 10 ( {I}_{Max} - {I}_{Min} )$$

The modulation amplitude must be greater than or close to 0 dBm, or even greater than 0 dBm. Imax and Imin are expressed in optical mW (optical milliWatt).

Note that Imax is also defined by the intensity I_{LA} of the radiation supplied by the laser to the input of the Mach-Zehnder modulator. More specifically, I_{MAX} is defined by the relationship I_{MAX}=I_{LA}×IL×cos(F), where IL represents insertion losses, and F is the phase shift (operating point) between the 2 modulation sections.

Typically, I_{LA} is approximately equal to 10 mW (or 10 dBm)

The modulation efficiency of the Mach-Zehnder modulator is quantified by the quantity M. In particular, this quantity M is generally written as the ratio of pi to a term Vpi, where Vpi is the voltage difference to be applied between one and the other of the two modulation sections to impose a phase shift of p between the first radiation and the second radiation. In this respect, it is known that the Vpi term is inversely proportional to the length L of the modulation sections, so that the greater the length L, the better the modulation efficiency.

Nevertheless, this condition does have an impact on the insertion loss IL and BW bandwidth of the Mach-Zehnder modulator. Increasing the length L increases the insertion loss IL and reduces the bandwidth BW of the Mach-Zehnder modulator under consideration.

By way of example, a modulation section formed in a silicon-on-insulator waveguide has the following characteristics

| | | |
|---|---|---|
| Losses of a | 22 | dB × L(cm) |
| modulation section | | |
| of length L | | |
| Vpi of a modulation | 1.8 | V/L (cm) |
| section of length L | | |
| Bandwidth BW for a | 25 | Ghz |
| length | 30 | Ghz |
| L = 4 mm | BW > 60 | Ghz |
| for a length | | |
| L = 3 mm | | |
| for a length | | |
| L = 1.5 mm | | |

Thus, a Mach-Zehnder modulator comprising two modulation sections of length L of the order of 0.4 cm as described in the preceding table, and operating in quadrature, has the following characteristics:

| | | |
|---|---|---|
| Vpi | 4.5 | V |
| Insertion losses in | 8.8 | dB |

| | |
|---|---|
| the modulation | (IL = 0.132) |
| section | |

Considering the following implementation conditions:
applying a modulation voltage of u(t)/2=−Vpp/2 to Vpp/2 on each of the “push/pull” sections (in other words, a voltage of u(t)/2 is applied to one of the modulation sections, while a voltage of −u(t)/2 is applied to the other of the modulation sections, where Vpp=2V);
an intensity of 10 dBm (10 mW) at the MZM's input I_{LA};

The intensities I_{MAX} and I_{MIN} are then defined by the following relationships:

$${I}_{MAX} = {I}_{LA} \times IL \times cos ( F ) \times ( 1 + cos ( M 1 ) )$$

$${I}_{MIN} = {I}_{LA} \times IL \times cos ( F ) \times ( 1 + cos ( M 2 ) )$$

$$where M 1 = pi / 2 + ( Vpp / 2 ) \times ( pi / Vpi ) , and M 2 = pi / 2 - ( Vpp / 2 ) \times ( pi / Vpi )$$

These considerations allow us to determine the extinction ratio ER and the optical modulation amplitude OMA, tabulated below:

| | | |
|---|---|---|
| ER | 6.6 | dB |
| OMA | −0.7 | dBm |

In order to increase the bandwidth BW of the Mach-Zehnder modulator, it is proposed to reduce the length L of the modulation sections. More particularly, and according to the present invention, the length L is less than a predetermined length Lp, said predetermined length being a length below which the bandwidth BW is greater than 35 GHZ, advantageously greater than 50 GHz, even more advantageously greater than 60 GHz. By way of example, the predetermined length Lp can be less than or equal to 3 mm, and for example be equal to 3 mm. Still by way of example, the predetermined length Lp can be less than or equal to 2.5 mm, and for example be equal to 2.5 mm. Still by way of example, the predetermined length Lp can be less than or equal to 2 mm, and for example be equal to 2 mm. Still by way of example, the predetermined length Lp can be less than or equal to 1.5 mm, and for example be equal to 1.5 mm.

In particular, it has been demonstrated that a modulation section length L equal to 1 mm gives a BW bandwidth equal to 70 GHz. However, such a Mach-Zehnder modulator (with losses of 22 dB/cm and a Vpi value=1.8 V/L (cm)), implemented at the quadrature point, will have a Vpi of 18 V. Thus, this Mach-Zehnder modulator, modulated at a modulation voltage Vpp=2Vpp, will have a reduced extinction ratio. By way of example, and under the conditions set out above, if the length L of the modulation sections is equal to 1 mm, the extinction ratio is reduced to 1.5 dB. At the same time, the OMA remains at an acceptable level of 0.2 dBm.

The extinction ratio is then well below the rates expected for error-free optical transmission. To overcome this problem, a higher modulation voltage can be considered. However, this last consideration leads to overconsumption, which is counterproductive (since consumption is approximately proportional to (Vpp)²). So, for example, to recover a 6 dB extinction ratio, a modulation voltage 4 times greater is required, that is Vpp=8V, and therefore a power consumption 16 times greater.

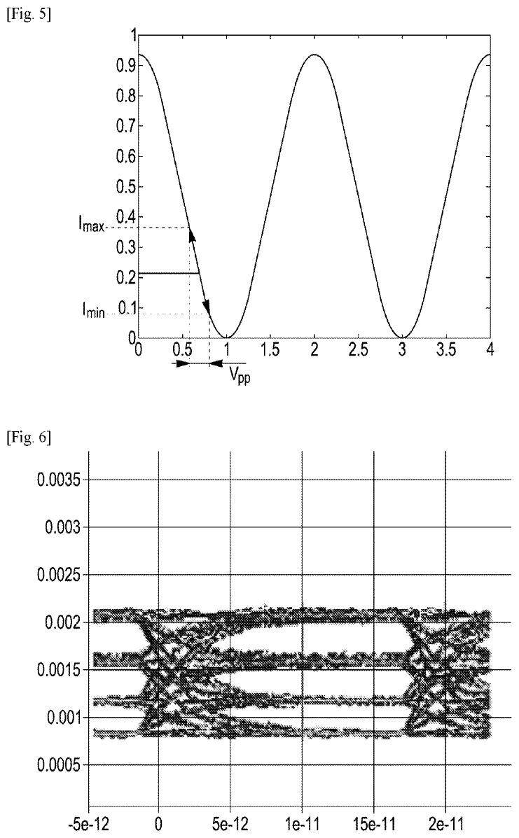

It is proposed here to juxtapose an SOA semiconductor optical amplifier with the Mach-Zehnder modulator, with the following characteristics for the Mach-Zehnder modulator and the SOA, ensuring lower overall transmitter power consumption:
1—Mach-Zehnder modulator characteristics: in order to keep the modulation voltage low (e.g. 2Vpp), while ensuring a sufficiently high extinction ratio, the modulator's operating point is shifted. In particular, the operating point can be adjusted to a value between 0.6*pi and 0.9*pi, advantageously between 0.65*pi and 0.85*pi, even more advantageously between 0.7*pi and 0.8*pi (FIG. 5). Consideration of an operating point in one of the above ranges increases the extinction ratio ER.

For example, under these conditions, if L=1 mm, Vpp=2V, and F=0.85×pi, the extinction ratio ER is 6.6 dB. The optical modulation amplitude OMA associated with such an operating point is penalized, and in particular becomes equal to −3.2 dBm. This OMA value is insufficient.
2—In order to compensate for this reduction in the optical modulation amplitude OMA, it is proposed to implement a semiconductor optical amplifier with SOA at output 104 of the Mach-Zehnder modulator. The gain of the semiconductor amplifier SOA is also adjusted to compensate for the loss of the OMA. SOA amplifiers are generally used after signal propagation in the optical fiber, as repeaters, to compensate for propagation losses in the fiber (usually after several tens of kilometers) [3]. According to the present invention, the semiconductor optical amplifier SOA is integrated in the transmitter, at the output of the Mach-Zehnder modulator. The SOA is implemented here with a gain of between 3 dB and 20 dB, for example equal to 3 dB, or 4.8 dB, or greater than 7 dB, or greater than 100 (that is 20 dB).

SOA power consumption remains low (approx. 1.2 V×50 mA, that is approx. 60 mWatt for a gain of 7 dB, or approx. 1.5 V×120 mA for a gain of 20 dB). This additional power consumption is much lower than the additional power consumption associated with using a modulation voltage 4 times higher (e.g. Vpp=8V compared with Vpp=2V). With a 3 dB gain, the OMA becomes acceptable and equal to −0.2 dBm. Finally, the use of the SOA at low gain offers another advantage: the implementation of low gain by a low SOA drive intensity is accompanied by a low noise figure [3].

### SUMMARY OF A FIRST EMBODIMENT OF THE INVENTION

The following table shows the characteristics of a Mach Zehnder modulator known from the prior art:

I_{LA}=10 dBm, L=4 mm, BW 30 GHZ

| Mach-Zehnder modulator | | | |
|---|---|---|---|
| operating point F | Vpp | ER | OMA (I_{LA} = 10 dBm) |
| 0.5*pi | 2 V | 6.6 dB | −0.7 dBm |

According to this embodiment, the bandwidth is insufficient

The table below shows the characteristics of a Mach-Zehnder modulator operating

in quadrature, where the length of the modulation sections is reduced to 1 mm (I_{LA}=10 dBm, L=1 mm, BW 70 GHZ). This reduction in length L significantly increases bandwidth.

| Mach-Zehnder modulator | | | |
|---|---|---|---|
| operating point F | Vpp | ER | OMA (I_{LA} = 10 dBm) |
| 0.5*pi | 2 V | 1.5 dB | 0.2 dBm |

The reduction in length L provides appreciable bandwidth, but the extinction ratio ER is still insufficient.

The table below shows the characteristics of a Mach-Zehnder modulator operating in quadrature, where the length of the modulation sections is reduced to 1 mm (I_{LA}=10 dBm, L=1 mm, BW 70 GHZ). This example proposes a modulation voltage 4 times higher than that proposed in the two previous tables.

| Mach-Zehnder modulator | | | |
|---|---|---|---|
| operating point F | Vpp | ER | OMA (I_{LA} = 10 dBm) |
| 0.5*pi | 8 V | 1.5 dB | 6 dBm |

By increasing the modulation voltage Vpp, an appreciable extinction ratio can be achieved, but the power consumption of the device in question is multiplied 16-fold.

### Proposed Embodiment 1

The table below shows the characteristics of a Mach-Zehnder modulator operating in quadrature, where the length of the modulation sections is reduced to 1 mm (I_{LA}=10 dBm, L=1 mm, BW 70 GHZ). This example uses a semiconductor optical amplifier (with a gain of 3 dB) and imposes a sufficiently low modulation voltage to limit power consumption:

| Mach-Zehnder modulator | SOA | | | |
|---|---|---|---|---|
| operating point F | gain | Vpp | ER | OMA (I_{LA} = 10 dBm) |
| 0.85*pi | 3 dB | 2 V | 6.6 dB | −0.2 dBm |

Figures of merit BW, ER, OMA are within specifications, with overconsumption reduced by the use of low-gain SOA (overconsumption of around 40 mW).

Implementing the present invention both reduces the size of a Mach-Zehnder modulator, and gives it a wider bandwidth than modulators known from the prior art.

What's more, a Mach-Zehnder modulator with a low-gain SOA ensures low power consumption and a low noise figure.

In a second embodiment, the SOA is used to reduce the intensity of the laser I_{LA}. It is well known that a laser ages more slowly when its supply intensity is lower, and therefore its optical intensity I_{LA} is lower. It is also common knowledge that an SOA has a lower noise figure when amplifying a signal of lower optical intensity at its input [3]. In this second embodiment of the invention, it is thus proposed to decrease the optical intensity I_{LA} of the laser by 3 dB, for example I_{LA}=7 dBm, and to compensate for this decrease by increasing the gain of the SOA by 3 dB, for example 6 dB. The table below summarizes the advantages of this second embodiment.

By way of example, the light radiation injected by the laser source (LA) has an intensity strictly below 10 dB, advantageously below 7 dB. In this case, the gain of the semiconductor optical amplifier is adjusted so that the signal at the output of the photonic chip has an intensity equivalent to that obtained by the said photonic chip without a semiconductor optical amplifier and at the input of which radiation of an intensity of 10 dB would have been injected.

### Second Embodiment (I_{LA}=7 dBm, L=1 mm, BW 70 GHZ)

| Mach-Zehnder modulator | SOA | | | |
|---|---|---|---|---|
| operating point F | gain | Vpp | ER | OMA (I_{LA} = 10 dBm) |
| 0.85*pi | 6 dB | 2 V | 6.6 dB | −0.2 dBm |

The figures of merit BW, ER and OMA are within specifications, with a 3 dB reduction in laser intensity and reduced power consumption thanks to the SOA, with a gain of 6 dB (additional power consumption of around 60 mW).

FIG. 6 is a graphical representation of an example eye diagram relating to the operation of a Mach-Zehnder modulator. This eye diagram is the result of a simulation based on a radiation intensity I_{LA} at the Mach-Zehnder modulator input of 10 dBm.

For the purposes of this simulation, the modulation sections have a length L equal to 1.5 mm, while the gain of the SOA semiconductor amplifier is equal to 4 (6 dB).

FIG. 6 is a graphical representation of an example eye diagram relating to the operation of a Mach-Zehnder modulator for which the length L of the modulation sections is 1.5 mm, and an operating point f equal to 0.75*pi.

This configuration gives an extinction ratio ER of 5.7 dB at Vpp=2V, and an optical modulation amplitude equal to 4.1 dBm.

The eye diagram, although slightly distorted (due to the choice of an off-quadrature operating point: F different from pi/2), shows a decent OMA and extinction ratio. In addition, the reduced length L of the modulation sections gives the Mach-Zehnder modulator a relatively high bandwidth, particularly in excess of 60 GHz.

In one embodiment, the first adjustment means 107 comprises a first heating element H_{F} configured to locally modify, by heating, the refractive index of either the first branch or the second branch in order to impose the set phase shift F.

Also advantageously, the photonic system 10 comprises first control means configured to control the first adjustment means 107.

The first control means comprise a first photodetector PD1 and a first analyzer SA1. In particular, these first means are configured to electrically collect (in part) and analyze the continuous or modulated signal from the Mach-Zehnder modulator 100.

A modulator M, connected to the first adjustment means 107. In particular, the M modulator can be configured so that the first adjustment means 107 impose a modulated phase shift F at a modulation frequency Fd, for example equal to 5 kHz. In particular, the phase shift F can be modulated according to the following law F+F·cos (2p·Fd·t)

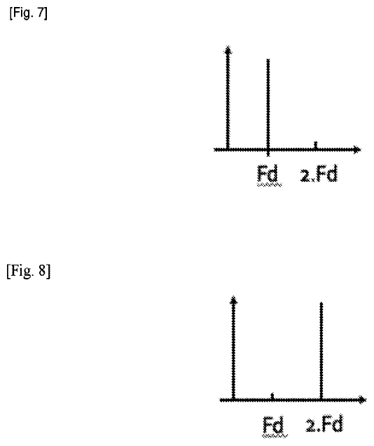

Such modulation allows detection of the quadrature point (F=pi/2) as well as the carrier suppression point (F=pi). In particular, when the first adjustment means 107 are modulated at the frequency Fd around the quadrature point, the modulated radiation partially collected by the first photodetector PD1 essentially comprises a harmonic at frequency Fd. FIG. 7 shows the Fourier transform obtained using the first analyzer, when this is an SA1 spectral analyzer.

In equivalent fashion, when the first adjustment means 107 are modulated at the frequency Fd around the carrier suppression point, the modulated radiation partially collected by the first photodetector PD1 essentially comprises a harmonic at frequency 2Fd. FIG. 8 shows the Fourrier transform obtained using the first spectral analyzer SA1.

The adjustment of the phase shift F in the range 0.6*pi-0.9*pi can be achieved by weighting the control signals of the first adjustment means 107 to impose the quadrature point (F=pi/2) and the carrier suppression point.

Advantageously, the Mach-Zehnder modulator comprises a radiation combiner CO configured to combine a first radiation and a second radiation that are phase-modulated, respectively, by the first branch and the second branch, the first radiation and the second radiation originating, before they are modulated by one of the modulation branches, from the division of light with wavelength 1.

According to a particular embodiment, the radiation combiner CO comprises two output channels referred to as first channel V1 and second channel V2, respectively.

In particular, the first V1 channel can be optically coupled with the first GC1 control guide, while the second channel can carry the SOA solid-state optical amplifier.

The photonic chip further comprises second means for adjusting an optical gain of the SOA semiconductor optical amplifier, advantageously the second adjustment means comprise a second heating element HsoA.

The photonic system comprises second control means configured to control the second adjustment means, said second control means comprising a second photodetector PD2 and a second spectral analyzer SA2.

Advantageously, the second photodetector PD2 is carried by a second control waveguide GC2 optically coupled to the second channel V2, the coupling being sized so that the second waveguide collects at most 10%, advantageously at most 5%, of the optical power flowing in the second channel V2.

The photonic chip may also comprise an optical filter FO carried by the second channel V2 and downstream of the semiconductor optical amplifier SOA.

Alternatively, the first photodetector PD1 can be on the SOA branch. In this case, the SOA gain is equal to the optical power on PD2/optical power on PD1 if the SOA output power collection going towards PD2 is equal to the SOA input power collection going towards PD1.

Complementarily, the photonic chip may further comprise third control means configured to determine the intensity of radiation delivered by the LA laser source. In particular, these third control means may comprise a third photodetector PD3 configured to detect in part the laser radiation emitted by the laser source LA. This third photodetector PD3 can be coupled to an analyzer enabling the intensity of the light radiation emitted by the laser source LA to be determined on the basis of the third photodetector PD3 alone.

These third control means are advantageously used to adjust the gain of the semiconductor optical amplifier SOA.

1. A photonic system provided with a photonic chip made in silicon technology, said photonic chip comprising:
a Mach-Zehnder modulator formed on and/or in a useful layer resting on one face of a supporting substrate, said Mach-Zehnder modulator comprising two modulation branches, called, respectively, first branch and second branch, each provided with a modulation section extending over a length L of less than 3 mm;
first means for adjusting the operating point of the Mach-Zehnder modulator, configured to impose an operating point associated with a set phase shift between the first and second branches;
a semiconductor optical amplifier formed on and/or in the useful layer and arranged downstream of the output of the Mach-Zehnder modulator, said semiconductor optical amplifier being configured to amplify a signal modulated by the Mach-Zehnder modulator, the semiconductor optical amplifier having an optical gain configured so that the optical modulation amplitude associated with the photonic chip, when the set phase shift is adjusted in the range 0.6pi-0.9pi, is between −3 dBm and 10 dBm, at an output port arranged downstream of the semiconductor optical amplifier.

2. The photonic system according to claim 1, wherein the first adjustment means comprises a first heating element configured to locally modify, by heating, the refractive index of either the first branch or the second branch in order to impose the set phase shift.

3. The photonic system according to claim 1, wherein said photonic system comprises first control means configured to control the first adjustment means.

4. The photonic system according to claim 3, wherein the first control means comprise a first photodetector and a first spectral analyzer.

5. The photonic system according to claim 4, wherein the Mach-Zehnder modulator comprises a radiation combiner configured to combine a first radiation and a second radiation that are phase-modulated, respectively, by the first branch and the second branch, the first radiation and the second radiation originating, before they are modulated by one of the modulation branches, from the division of light radiation.

6. The photonic system according to claim 5, wherein the photonic chip further comprises second means for adjusting an optical gain of the semiconductor optical amplifier.

7. The photonic system according to claim 6, wherein said photonic system comprises second control means configured to control the second adjustment means, said second control means comprising a second photodetector and a second spectral analyzer.

8. The photonic system according to claim 7, wherein the radiation combiner comprises two output channels referred to as, respectively, a first channel and a second channel, the second channel carrying the semiconductor optical amplifier, the second control means being carried by a second control waveguide optically coupled to the second channel, the coupling being sized so that the second waveguide taps at most 10%, of the optical power flowing in the second channel.

9. The photonic system according to claim 8, wherein the photonic chip also comprises an optical filter carried by the first channel and downstream of the semiconductor optical amplifier.

10. The photonic system according to claim 5 wherein the photonic chip comprises a laser source configured to inject light radiation at wavelength to an input of the Mach-Zehnder modulator.

11. The photonic system according to claim 10, wherein the laser source is a tunable laser source.

12. A photonic system provided with a photonic chip made in silicon technology, said photonic chip comprising:
a Mach-Zehnder modulator formed on and/or in a useful layer resting on one face of a supporting substrate, said Mach-Zehnder modulator comprising two modulation branches, called, respectively, first branch and second branch, each provided with a modulation section extending over a length of less than 3 mm;
first means for adjusting the operating point of the Mach-Zehnder modulator, configured to impose an operating point associated with a set phase shift between the first and second branches;
a semiconductor optical amplifier formed on and/or in the useful layer and arranged downstream of the output of the Mach-Zehnder modulator, said semiconductor optical amplifier being configured to amplify a signal modulated by the Mach-Zehnder modulator, the semiconductor optical amplifier having an optical gain configured so that the optical modulation amplitude associated with the photonic chip, when the set phase shift is adjusted in the range 0.6pi-0.9pi, is between −3 dBm and 10 dBm, at an output port arranged downstream of the semiconductor optical amplifier, wherein the photonic chip comprises a laser source configured to inject light radiation at wavelength to an input of the Mach-Zehnder modulator, wherein the light radiation injected by the laser source is of an intensity strictly less than 10 dB, and wherein the gain of the semiconductor optical amplifier is adjusted so that the signal at the output of the photonic chip has an intensity equivalent to that obtained by the said photonic chip without a semiconductor optical amplifier and at the input of which radiation of an intensity of 10 dB would have been injected.

13. The photonic system according to claim 12, wherein the light radiation injected by the laser source is of an intensity strictly less than 7 dB.

14. The photonic system according to claim 12, wherein said photonic system comprises first control means configured to control the first adjustment means.

15. A photonic system provided with a photonic chip made in silicon technology, said photonic chip comprising:
a Mach-Zehnder modulator formed on and/or in a useful layer resting on one face of a supporting substrate, said Mach-Zehnder modulator comprising two modulation branches, called, respectively, first branch and second branch, each provided with a modulation section extending over a length of less than 3 mm;
first means for adjusting the operating point of the Mach-Zehnder modulator, configured to impose an operating point associated with a set phase shift between the first and second branches;
a semiconductor optical amplifier formed on and/or in the useful layer and arranged downstream of the output of the Mach-Zehnder modulator, said semiconductor optical amplifier being configured to amplify a signal modulated by the Mach-Zehnder modulator, the semiconductor optical amplifier having an optical gain configured so that the optical modulation amplitude associated with the photonic chip, when the set phase shift is adjusted in the range 0.6pi-0.9pi, is between −3 dBm and 10 dBm, at an output port arranged downstream of the semiconductor optical amplifier, wherein the laser source is a tunable laser source, wherein the light radiation injected by the laser source is of an intensity strictly less than 10 dB, and wherein the gain of the semiconductor optical amplifier is adjusted so that the signal at the output of the photonic chip has an intensity equivalent to that obtained by the said photonic chip without a semiconductor optical amplifier and at the input of which radiation of an intensity of 10 dB would have been injected.

16. The photonic system according to claim 15, wherein the light radiation injected by the laser source is of an intensity strictly less than 7 dB.

17. The photonic system according to claim 15, wherein said photonic system comprises first control means configured to control the first adjustment means.

18. The photonic system according to claim 5, wherein the second adjusting means comprise a second heating element.

19. The photonic system according to claim 7, wherein the coupling being sized so that the second waveguide taps at most 5% of the optical power flowing in the second channel.
